(19) United States
(12) Patent Application Publication
(10) Pub. No.: US 2003/0097915 A1
(43) Pub. Date: May 29, 2003

(54) Flexible cutting boards

(76) Inventors: Paul N. Chen, Canandaigua, NY (US); Margaret A. Curulla, Honeoye Falls, NY (US); Gary D. Ennis, Canandaigua, NY (US); Thomas A. White, Farmington, NY (US); William P. Belias, Pittsford, NY (US)

Correspondence Address: Ronald B. Coolley, Jenkens & Gilchrist, 3200 Fountain Place, 1445 Ross Avenue, Dallas, TX, 75202, US

(21) Appl. No.: 09/973,028

(22) Filed: Oct. 9, 2001

(51) Int. Cl. B23Q 3/00

(52) U.S. Cl. 83/13; 269/289 R; 83/932

(57) ABSTRACT

A flexible disposable cutting board comprises a polyolfin resin, such as polypropylene, and from about 10 to about 85 wt. % calcium carbonate. The cutting board generally has a thickness of from about 5 mils to about 12 mils. The flexible, disposable cutting board is preferably cut resistant, foldable, and has water and microwave stability. The cutting board preferably has foldability without cracking after being stored.

### FIELD OF THE INVENTION

The present invention relates generally to cutting boards, and, more specifically, to flexible cutting boards that are disposable, cut resistant, and microwave and water stable.

### BACKGROUND OF THE INVENTION

A common tool in household and commercial kitchens is a cutting board. Often these cutting boards are rigid blocks of wood, plastic or Formica which have several deficiencies which limit their use. These cutting boards can dull cutting knives and the boards themselves are often damaged by the cutting tools used. These cutting boards are hard to clean, are subject to staining and retain odors. Due to their size and rigidity, these cutting boards are difficult to handle and store.

Recently, health concerns have been raised as a result of the porosity of the cutting boards and the cuts therein. Reports have been published that bacteria can grow in these spaces and can transfer to food placed on the cutting boards. Thorough cleaning of these cutting boards may reduce the danger of this bacteria but this is not totally effective.

Attempts have been made to solve these problems. Multi-layered cutting boards wherein a top layer is peeled off the cutting board after each use have been tried. This and other attempts are expensive and often are impractical. It is desirable to provide an inexpensive, easily stored cutting board that can be disposed of before contamination is a risk.

### SUMMARY OF THE INVENTION

The flexible, disposable cutting board comprises a polyolefin resin, such as a polypropylene, and from about 10 to about 85 wt. % calcium carbonate. The cutting board generally has a thickness of from about 5 mils to about 12 mils. The cutting board is preferably cut resistant, foldable and has water and microwave stability. The cutting board preferably has foldability without cracking after being stored at about 60° C. for twenty-four hours. A further embodiment of this cutting board includes a bottom layer of a patterned design to provide a substantially non-skid surface.

### BRIEF DESCRIPTION OF THE DRAWINGS

Other objects and advantages of the invention will become apparent upon reading the following detailed description in conjunction with the drawings in which:

FIG. 1 is a perspective view of a cutting board constructed in accordance with the principles of the present invention, and

FIG. 2 is a cross sectional view of a cutting board according to another embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the intention is to cover all modifications, equivalents, and alternatives falling within the spirit and scope of the invention as defined by the appended claims.

### DESCRIPTION OF ILLUSTRATIVE EMBODIMENTS

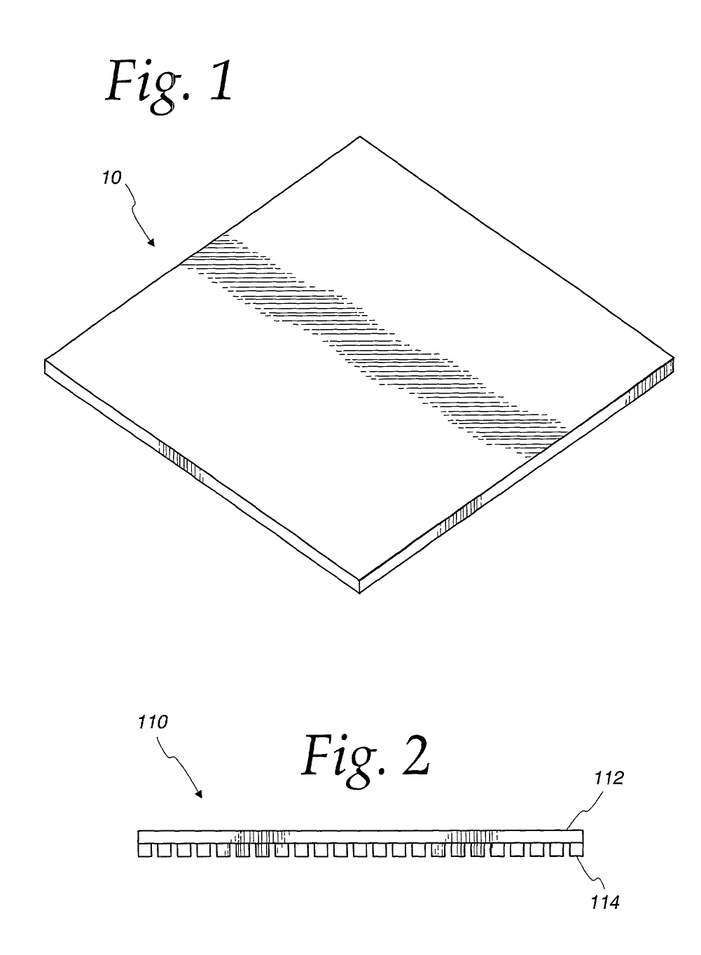

Referring to FIG. 1, there is illustrated a flexible, disposable cutting board 10 of the present invention. The cutting board is preferably light, low cost, water inert, foldable, cut resistant and thermal and microwave stable. The cutting board 10 is shown as square in FIG. 1 but any configuration may be used. It has been determined that a thickness of from about 5 mils to about 12 mils of the cutting board is preferred for durability and foldability.

The cutting board 10 of the present invention comprises a polyolefin and calcium carbonate. One example of a polyolefin that may be used is polypropylene. Polypropylene and calcium carbonate, is typically referred to as calcium carbonate filled polypropylene or CFPP. Another contemplated polyolefin is a cyclic olefin copolymer (COC).

The cyclic olefin copolymers generally have a molecular weight distribution or polydispersity (M_{w}/Mₙ, “MWD”) from about 2.0 to about 5.0, and preferably from about 2.0 to about 2.5. The cyclic olefin copolymers generally have a density of from about 0.90 to about 1.10 g/cm³, typically from about 0.95 to about 1.05 g/cm³ and more typically from about 1.00 to about 1.03 g/cm³. The heat deflection temperature (HDT, measured at 66 psi) of cyclic olefin copolymers generally is from about 50 to about 200° C., and typically from about 70 to about 170° C. The melt flow index (MI) of the cyclic olefin copolymers is generally from about 1 to about 100 g/10 min. and typically from about 4 to about 20 g/10 min. at 115° C. (239° F.) above its corresponding HDT as determined by ISO 1133.

The cyclic olefin copolymers may be made from copolymers of ethylene and norbornene. The mole % of ethylene and norbornene may vary with respect to each other. For example, the amount of norbornene is generally from about 10 to about 90 mol. %, with the remainder being ethylene (from about 10 to about 90 mol. %). The amount of norbornene is typically from about 20 to about 70 mol. % with the remainder being ethylene. The amount of norbornene is more typically from about 35 to about 60 mol. % with the remainder being ethylene. The cyclic olefin copolymers may be made using metallocene catalysts.

The glass transition temperature (T_{g}) of the cyclic olefin copolymer is generally greater than about 20° C., typically greater than about 50° C., and preferably greater than about 75° C., as measured by ASTM D3418. The glass transition temperature of the cyclic olefin copolymer may be greater than about 100° C. or about 150° C. as measured by ASTM D3418. The glass transition temperature (T_{g}) of the cyclic olefin copolymers increases as the mole % of norbornene in the copolymer increases. For example, the glass transition temperature (T_{g}) of a cyclic olefin copolymer comprising 20 mol. % norbornene and 80 mol. % ethylene is about 25° C., while the glass temperature transition of a cyclic olefin copolymer comprising 70 mol. % norbornene and 30 mol. % ethylene is about 210° C. The glass temperature transition (T_{g}) of a cyclic olefin copolymer comprising 30 mol. % norbornene and 70 mol. % ethylene is about 75° C., while a cyclic olefin copolymer comprising 60 mol. % norbornene and 40 mol. % ethylene is about 180° C.

The flexural modulus of the cyclic olefin copolymer is generally from about 300,000 to about 600,000 psi, and more specifically from about 400,000 to about 500,000 psi as measured by ASTM D790. The tensile modulus of the cyclic olefin copolymers is generally from about 300,000 to about 600,000 psi, and more specifically from about 400,000 to about 500,000 psi, as determined by ISO 527.

Useful cyclic olefin copolymers are available from several companies. For example, Ticona, a business of Celanese AG, in Summit, N.J. has cyclic olefin copolymers available. Other companies that have cyclic olefin copolymers available include Nippon Zeon Co., Ltd. (Japan) and Mitsui Chemical (Japan). Nippon Zeon Co., Ltd. has commercially available cyclic olefin copolymers (COCs) under the designation ZEONEX®. Ticona, a business of Celanese AG, has commercially available cyclic olefin copolymers (COCs) under the designation TOPAS®. The cyclic olefin copolymers which are commercially available under the designation TOPAS® are believed to be prepared with feedstocks of norbornene and ethylene and the use of a metallocene catalyst. There are believed to be at least four grades of TOPAS® resins available (TOPAS® 8007, TOPAS® 6013, TOPAS® 6015, and TOPAS® 6017). The four grades of TOPAS® resins available have glass transition temperatures, T_{g}, of 85, 140, 160 and 180° C., respectively. The corresponding norbornene levels of the four grades of TOPAS® resins are believed to be about 35, 48, 55 and 59 mol. %.

The cutting board 10 comprises from about 10 to about 85 wt. % calcium carbonate and, more specifically, from about 50 or 60 to about 85 wt. % calcium carbonate. Cutting board 10 may comprise from about 60 to about 75 wt. % calcium carbonate.

One example of a calcium carbonate filled polypropylene (CFPP) that may be obtained is made by Spectra Polycom and contains about 40 wt. % calcium carbonate. It is contemplated that other calcium carbonate filled polypropylenes may be used. The cutting board 10 of the present invention may be made of varying thickness, but generally has a thickness of from about 5 mils to about 12 mils.

The cutting board preferably can be folded at least in half (180 degrees) and preferably in quarters. The cutting board 10 has unique properties such as being foldability without cracking after being stored at about 60° C. for twenty-four hours. In other words, after being folded in half, the cutting board can be opened and still remain generally flat.

The cutting board 10 also has a desirable impact strength as determined by ASTM D 5420 (Gardner Impact test). The impact strength of the cutting board 10 is generally greater than about 1.0 in-lbs. and preferably greater than about 1.5 in-lbs. at room temperature as determined by ASTM D 5420. The cutting board 10 also has an elongation of greater than about 10% and preferably greater than about 50% at room temperature as determined by ASTM D 638.

The cutting board 10 may have additional layers than depicted in FIG. 1. For example, the cutting board 10 may have two or more layers such as depicted in FIG. 2. FIG. 2 depicts a cutting board 110 that has a layer for increased slip resistance which is often a desirable characteristic because cutting boards may be used on surfaces, such as counter surfaces, that tend to be slippery.

The cutting board 110 includes a first layer 112 and a second layer 114. The first layer 112 and the second layer 114 may be formed separated and then adhesively joined to form the cutting board 110. Alternatively, the first layer 112 and the second layer 114 may be coextruded to form the cutting board 110 The cutting board 110 may be formed by injection molding using dual injectors or laminating two separate sheets.

The first layer 112 of the cutting board 110 is shown as being sized identically and made of the same materials as the cutting board 10. The second layer 114 is patterned to provide enhanced friction and form a substantially non-skid surface. The second layer 114 is preferably made of a material that is compatible with the material of the first layer 112. Examples of suitable material for the bottom layer 114 may include unfilled polypropylene copolymer, impact modified polypropylene such as crosslinked ethylene propylene diene monomer/polypropylene (EPDM/PP), polypropylene containing tackifying additives such as ethylene vinyl acetate (EVA) and polyisobutylene, or polypropylene blends such as polypropylene and nylon. It is contemplated that the second layer 114 may be made of other materials that enhance the friction of the cutting board 110.

### EXAMPLES

Cutting boards of the present invention were evaluated to determine various characteristics as compared to cutting boards made of different materials. The testing indicated that the cuttings boards made from different weight percentages of calcium carbonate filled polypropylene (CFPP) compositions had a unique combination of properties as compared to the other cutting boards.

Table 1 provides several mechanical properties at room temperature of 60 wt. % and 70 wt. % CFPP, 40 wt. % talc filled polypropylene (TFPP) and unfilled PP (no filler):

TABLE 1

| | | | Ten | | | Flexural | Gardner |
|---|---|---|---|---|---|---|---|
| Composition | wt. % of Filler | Thickness | Strength⁷ | Elong.⁵ | Modulus⁹ | Modulus¹⁰ | Impact¹¹ |
| 1 | 40% TFPP¹ | 11 mils; MD⁵ | 5.6 kpsi | 2% | 573 kpsi | 764 kpsi | 0.6 in-lbs. |
| 1 | 40% TFPP | 11 mils; TD⁶ | 4.7 kpsi | 1% | 491 kpsi | 638 kpsi | |
| 2 | 70% CFPP² | 11 mils; MD | 2.4 kpsi | 1% | 379 kpsi | 673 kpsi | 1.6 in-lbs |
| 2 | 70% CFPP | 10 mils; TD | 2.0 kpsi | 1% | 534 kpsi | 586 kpsi | |
| 3 | 60% CFPP | 10 mils; MD | 3.1 kpsi | >100% | 557 kpsi | 693 kpsi | 8.5 in-lbs |
| 3 | 60% CFPP | 10 mils; TD | 2.8 kpsi | 12% | 469 kpsi | 690 kpsi | |
| 4 | 0% PP³ | 15 mils; MD | 4.6 kpsi | >100% | 153 kpsi | 272 kpsi | 2.9 in-lbs |
| 4 | 0% PP | 15 mils; TD | 4.4 kspi | >100% | 151 kpsi | 284 kpsi | |
| 5 | 0% PVC⁴ | 9 mils; MD | 7.6 kpsi | 7% | 333 kpsi | 707 kpsi | 4.9 in-lbs |
| 5 | 0% PVC | 9 mils; TD | 6.9 kpsi | 4% | 298 kpsi | 692 kpsi | |

¹TFPP = Talc filled polypropylene with 3.0 μm talc.
²CFPP = Calcium carbonate filled polypropylene with 1.4 μm calcium carbonate from OMYA (steric acid treated).
³PP = 100 wt. % polypropylene.
⁴PVC = polyvinyl chloride.
⁵MD = machine direction.
⁶TD = transverse direction.
⁷The tensile strength was determined by ASTM D 638.
⁸The elongation was determined by ASTM D 638.
⁹The modulus was determined by ASTM D 638.
¹⁰The flexural modulus was determined by ASTM D 790.
¹¹The Gardner Impact was determined by ASTM D 5420.

Referring to Table 1, it was surprising that the addition of the calcium carbonate to the polypropylene provided similar or improved elongation as compared to a talc filled polypropylene (compare Composition 1 with Compositions 2-3). The unfilled polypropylene (Composition 4) also had desirable elongation, but the combination of the other mechanical properties (modulus, flexural modulus and Gardner Impact values) were generally much less desirable than Compositions 2-3.

Folding Test

A folding test was performed on Sheets 1-5 of Table 2 below. Sheets 1-5 were 8 inches by 11 inches, and each sheet was tri-folded. One sample of each sheet was then opened to determine the percentage of flatness that retained prior to thermal treatment. The percentage of flatness was determined visually. A flatness percentage of 100% meant that the sheet was substantially flat. A 50% flatness meant that the sheet was in a generally shape of a “U.” A 0% flatness meant that the two outer portions were touching in a shape of an equilateral triangle.

A different sample of Sheets 1-5 was placed in an oven set at 60° C. for 24 hours. The sheets were removed and unfolded. Again, the percentage of flatness retained was visually determined. Additionally, the sheets were visually inspected to determine whether cracks had developed after the heat treatment. The results from the visually inspection of the cracks are reported in Table 2 as the number of cracked samples per number of samples. For example, “0/1” means that the one inspected sample did not have any cracks.

TABLE 2

| | | Percentage | Percentage | |
|---|---|---|---|---|
| | | of Flatness | of Flatness | Sheet Samples |
| | Material | Retained | Retained | That Develop |
| Sheet | Description | (Before Heat | (After Heat | Cracks (After |
| No. | (wt. %) | Treatment) | Treatment) | Heat Treatment) |
| 1 | 60% CFPP¹ | 100% Flat | 100% Flat | 0/1 |
| 2 | 100% PP² | 50% Flat | 0% Flat | 0/1 |
| 3 | 100% PVC³ | 35% Flat | 0% Flat | 0/1 |
| 4 | 100% HIPS⁴ | 35% Flat | 0% Flat | 1/1 |
| 5 | 40% TFPP⁵ | 100% Flat | 0% Flat | 1/2 |

¹CFPP = calcium carbonate filled polypropylene with 1.4 μm calcium carbonate from OMYA (steric acid treated).
²PP = 100 wt. % polypropylene.
³PVC = 100 wt. % polyvinyl chloride.
⁴HIPS = 100 wt. % high impact polystyrene.
⁵TFPP = talc filled polypropylene with 3.0 μm talc.

As noted in Table 2, Sheet No. 1 (60 wt. % CFPP) was the only sample to maintain its original shape and flatness before and after the heat treatment. Sheets 2-5 did not return to their initial shape after being folded without heat treatment. Sheets 2-5 remained in a folded position (0% flat) after the heat treatment and thus, could not adequately perform as a cutting board. Additionally, Sheet 4 (HIPS) and Sheet 5 (TFPP) developed cracks along the folded edge, which increased in length after the heat treatment. In contrast, Sheet 1 (60 wt. % CFPP) was able to fully recover from the heat treatment while maintaining its hinge-like properties.

Durability and Cut Resistance Test

To test the cutting boards for durability and cut resistance, several cutting tests were performed on cutting boards with a variety of materials and thicknesses. The tests were performed on cutting boards measuring 12 inches by 12 inches (except where otherwise noted). The testing on the cutting boards were conducted on three sections of each cutting board. Specifically, a steak knife, a carving knife and a chef's knife were each used to make from 15 to 20 cuts in potatoes in each of the three cutting board sections. Each cutting board section was then visually examined and the number of cuts into the cutting board was counted and assigned a “0”, “1” or a “2”. A “0” signified 0 cuts into the board; a “1” signified 3 or less cuts into the board; a “2” signified 4 or more cuts into the board. To be considered a “cut”, it needed to extend entirely through the cutting board. The results of this testing are set forth in Table 3.

TABLE 3

| | | | | | | Estimated |
|---|---|---|---|---|---|---|
| | Material | | Cut Resistance¹³ | | | Sample |
| Board | Description | Thickness¹² | A | B | C | Weight |
| Number | (wt. %) | (mils) | Steak | Carving | Chef | (gms)/Size¹⁴ |
| 1 | 70% CFPP¹ | 11 mils | 0 | 0 | 0 | 42 gms |
| 2 | 60% CFPP | 8 mils | 0 | 0 | 0 | 35 gms |
| 3 | 50% CFPP | 10 mils | 2 | 2 | 1 | 32 gms |
| | | (Two 5 mils | | | | |
| | | taped | | | | |
| | | together) | | | | |
| 4 | 40% TFPP² | 12 mils | 1 | 0 | 0 | 35 gms |
| | (Film) | (Two 6 mils | | | | |
| | | taped | | | | |
| | | together) | | | | |
| 5 | PVC³ | 10 mils | 1 | 2 | 1 | 35 gms |
| | | (Two 5 mils | | | | |
| | | taped | | | | |
| | | together) | | | | |
| 6 | PVC | 13 mils | 0 | 0 | 0 | 43 gms |
| | (Bottom of | | | | | |
| | report cover) | | | | | |
| 7 | PVC | 8 mils | 2 | 2 | 1 | 38 gms |
| | (Top of report | | | | | |
| | cover) | | | | | |
| 8 | HIPS⁴ | 16.5 mils | 0 | 0 | 0 | 40 gms |
| 9 | OPS⁵ | 16 mils | 0 | 0 | 0 | 40 gms |
| 10 | Paperboard⁶ | 18.0 mils | 0 | 0 | 0 | NA¹⁵ |
| | | | | | | (11″ × 14″) |
| 11 | Random | 22.0 mils | 0 | 0 | 0 | NA |
| | Copolymer⁷ | | | | | (11.5″ × 15″) |
| 12 | Block | 24.0 mils | 0 | 0 | 0 | NA |
| | Copolymer⁸ | | | | | (12 ″ × 15″) |
| 13 | HMWPE⁹ | 22.0 mils | 2 | 2 | 2 | NA |
| | | | | | | (10″ × 7.5″) |
| 14 | PP¹⁰ | 12 mils | 0 | 0 | 0 | 23 gram |
| | | (Two 6 mils | | | | (10.5″ × 12″) |
| | | taped | | | | |
| | | together) | | | | |
| 15 | PP | 15 mils | 0 | 0 | 0 | (11″ × 14″) |
| 16 | 10% | 8 mils | 2 | 2 | 2 | NA |
| | COC/90% | (Two 4 mils | | | | |
| | LLDPE¹¹ | taped | | | | |
| | | together) | | | | |
| 17 | 20% COC/80 | 8 mils | 2 | 2 | 2 | NA |
| | % LLDPE | (Two 4 mils | | | | |
| | | taped | | | | |
| | | together) | | | | |

¹CFPP = calcium carbonate filled polypropylene as described above in Table 1.
²TFPP = talc filled polypropylene as described above in Table 1.
³PVC = polyvinyl chloride from Formosa Plastics.
⁴HIPS = high impact polystyrene.
⁵OPS = orientated polystyrene.
⁶Paperboard = 0.5 mil polyethylene (PE) coated paperboard sold under CUT & TOSS ™ brand
⁷Random Copolymer = PP/PE random copolymer with 4% ethylene sheet sold under CHOP & CHOP ® brand
⁸Block Copolymer = PP/PE block copolymer with 4% ethylene sold under the PROGRESSIVE INTERNATIONAL ® brand.
⁹HMWPE = High molecular weight polyethylene and includes cellulose fibers
¹⁰PP = Polypropylene homopolymer from Basell
¹¹COC = A cyclic olefin copolymer (COC) from Ticona, a division of Celanese AG, designated as TOPAS ® 6013 and LLDPE is a linear low density polyethylene.
¹²The sample was a single layer unless otherwise noted.
¹³The cut resistance was rated using a “0”, “1” or “2”. A “0” signified zero cuts. A “1” signified 3 or less cuts into the cutting board. A ″2″ signifies 4 or more cuts into the cutting board.
¹⁴The sample size was 12 inches × 12 inches (12″ × 12″) unless otherwise noted.
¹⁵Not available.

The results from the durability and cut resistance test indicated that the 60 wt. % and 70 wt. % of CFPP (Boards 1 and 2) performed well with no cuts being observed from either the steak, carving or chef knives. The 50 wt. % CFPP (Board 3) did not have the cut resistance as observed in Boards 1 and 2. It is believed that a single 10 mil sheet (instead of two 5 mil sheets taped together) would have improved the cut resistance of Board 3. The 40 wt. % TFPP (Board 4) also performed well with only cuts being observed from the steak knife. The remaining cutting boards (Boards 5-17) had varying results from the durability and cut resistance test. The thicker cutting boards (Boards 8-12) seemed to perform better in providing cut resistance than the thinner cutting boards like Boards 5, 7, 16 and 17.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A flexible, disposable cutting board, comprising:
a first polymeric layer, the first polymeric layer comprised of a polyolefin resin and from about 10 wt. % to about 85 wt. % calcium carbonate filler.

2. The cutting board of claim 1, wherein the thickness of the first polymeric layer is from about 5 mils to about 12 mils.

3. The cutting board of claim 1 further including a second polymeric layer, the second polymeric layer having a pattern design to provide a substantially non-skid surface.

4. The cutting board of claim 1, wherein the cutting board comprises from about 50 wt. % to about 85 wt. % calcium carbonate filler.

5. The cutting board of claim 1, wherein the cutting board comprises from about 60 wt. % to about 85 wt. % calcium carbonate filler.

6. The cutting board of claim 1, wherein the cutting board has foldability without cracking after being stored at about 60° C. for twenty-four hours.

7. The cutting board of claim 1, wherein the cutting board has Gardner Impact of greater than about 1.0 in-lbs. at room temperature determined by ASTM D 5420.

8. The cutting board of claim 1 further including a second polymeric layer, the second polymeric layer being an unfilled polypropylene copolymer.

9. The cutting board of claim 1 further including a second polymeric layer, the second polymeric layer being a crosslinked ethylene propylene diene monomer/polypropylene.

10. The cutting board of claim 1 further including a second polymeric layer, the second polymeric layer comprises a polypropylene with a tackifying additive.

11. The cutting board of claim 1 further including a second polymeric layer adapted to provide enhanced friction and an adhesive located between the first and second polymeric layers.

12. The cutting board of claim 1, wherein the cutting board has an elongation of at least about 10% as determined by ASTM D 638.

13. The cutting board of claim 1, wherein the polyolefin resin is polypropylene.

14. The cutting board of claim 1, wherein the polyolefin resin is a cyclic olefin copolymer.

15. A method of cutting food items on a disposable cutting board, comprising:
providing a cutting board from about 5 mils to about 12 mils thick comprising a polyolefin resin and from about 10 wt. % to about 85 wt. % calcium carbonate filler;
unfolding the cutting board;
placing the cutting board on a surface;
placing at least one food item on the cutting board; and
cutting the at least one food item.

16. The method of claim 15 further comprising disposing of the cutting board.

17. The method of claim 15, wherein the cutting board comprises from about 50 wt. % to about 85 wt. % calcium carbonate filler.

18. The method of claim 15, wherein the cutting board comprises from about 60 wt. % to about 85 wt. % calcium carbonate filler.

19. The method of claim 15, wherein the polyolefin resin is a polypropylene.

20. The method of claim 15, wherein the polyolefin resin is a cyclic olefin copolymer.

21. A flexible, disposable cutting board, comprising:
a first polymeric layer, said polymeric layer being made of a polypropylene resin and from about 10 wt. % to about 85 wt. % calcium carbonate filler and wherein the thickness of said first polymeric layer is from about 5 mils to about 12 mils.

22. The cutting board of claim 21, wherein said cutting board comprises from about 50 wt. % to about 85 wt. % calcium carbonate filler.

23. The cutting board of claim 21, wherein said cutting board comprises from about 60 wt. % to about 85 wt. % calcium carbonate filler.
